(19) United States
(12) Patent Application Publication
(10) Pub. No.: US 2021/0197409 A1
(43) Pub. Date: Jul. 1, 2021

(54) DESIGN OF ROBOT GRIPPERS AND FIXTURES FOR ROBOTIC MANUFACTURING

(71) Applicant: SYDDANSK UNIVERSITET, Odense M (DK)

(72) Inventors: Norbert KRÜGER, Odense N (DK); Lukas Cristoffer, Malte, Wiuf SCHWARTZ, Odense M (DK); Lars-Peter ELLEKILDE, Odense S (DK)

(21) Appl. No.: 16/754,963

(22) PCT Filed: Oct. 12, 2018
(86) PCT No.: PCT/EP2018/077870

§ 371 Date: Apr. 9, 2020

(30) Foreign Application Priority Data
Oct. 13, 2017 (EP) 17196424.0

(51) Int. Cl. B25J 19/00; B25J 15/00

(52) U.S. Cl. CPC B25J 19/007; B25J 11/00; B25J 15/0033

(57) ABSTRACT

The invention relates to a method for designing grippers and fixtures for handling objects in robotic manufacturing and pick-and-place tasks. To achieve this a method for determining a shape of the holding or support surface of the gripper or fixture is presented. This method includes steps of determining an initial shape of the support surface based on an outer shape of the object, applying a shaping function to different locations of the initial shape, determining modified shape points at locations of the initial shape by comparing the applied shaping function with the initial shape. If the application of the shaping function results in an extension of the initial shape G(xi,yj) at the neighbour location (xi, yj) this extension forms part of a modified support surface for the gripper or fixture. A method for determining an optimum shape of the support surface with respect to optimization conditions is also presented.

### FIELD OF THE INVENTION

The invention relates to grippers, fingers and fixtures for robotic manufacturing, particularly to design methods for such devices.

### BACKGROUND OF THE INVENTION

Robotic assembly processes are often concerned with picking up and fitting two or more objects together before they are securely fixed. In robotic system this may be achieved by use of grippers and fixtures which are arranged for holding the objects in a suitable way. For example, two individual robots may be configured with grippers to enable the robots to pick up the objects of the two-object assembly and to collaboratively assemble the objects. In another example, one robot is configured with a gripper arranged to hold a first object of a two-object assembly. A fixture is arranged to hold the other object. The other object may be placed by the same or another robot in the fixture. The grippers may be designed in various ways, e.g. as two parallel fingers provided with a suitable cut-out for holding the object.

Designing fixtures and gripping fingers is a problem that takes several iterations of trial and error evaluations, even for engineers using experience, heuristics and guidelines in the process.

Accordingly, in order to make robot assisted assembly processes more attractive there is need for improving procedures and devices used in robot-automated assembly processes.

### SUMMARY OF THE INVENTION

It is an object of the invention to improve robot assisted assembly or placement processes. It is another object to improve design processes for obtaining optimised tools such as grippers and fixtures for use in such processes. Particularly, it is an object to improve automation of such design processes.

In a first aspect of the invention there is provided a method for determining a shape Gm(x,y) of a support surface of a robot-gripper or fixture used for supporting an object picked up by a robot during robotic manufacturing, the method comprises
determining an initial shape G(x,y) of the support surface for the robot-gripper or the fixture based on an outer shape of the object, where the initial shape is a function of locations (x,y) on a reference surface,
providing a shaping function F(q) being a function of at least a parameter q determined relative to a selected location (xs,ys) selected among the locations (x,y),
applying the shaping function F(q) to a plurality of the selected locations (xs,ys),
at a plurality of neighbour locations (xi,yj) to the selected locations (xs,ys), determine modified shape points Gm(xi, yj) based on the applied shaping function F(q) and the initial shape G(xi, yj),
if a modified shape point Gm(xi, yj) provides an extension of the initial shape G(xi,yj) at the neighbour location (xi, yj), use the modified shape point Gm(xi, yj) as a shape point in the shape Gm(x,y) of the support surface.

In other words the method is a process for automated determination of a support shape Gm(x,y). The process includes determination of an initial shape G(x,y) which is a function of locations (x,y) on a reference surface, e.g. a 2D reference plane of a Cartesian coordinate system. The shaping function F(q) is applied at points of the initial shape G(x,y), i.e. on the selected locations (xs, ys) of the initial shape. If the shaping function provides an extension of the initial shape G(xi,yj) at different locations (xi, yj), the modified shape point Gm(xi, yj) at a given location (xi, yj) is used instead of the initial shape point G(xi, yj), i.e. the modified shape point Gm(xi, yj) constitutes a shape point in the final shape Gm(x,y) of the support surface.

Advantageously, the numerical design process only requires little input in the form of an initial shape G(x,y) or an outer shape of the object. Based on this, the design process automatically determines a final shape Gm(x,y). The numerical process is relatively simple and therefore does not require long computation time or expensive computer equipment. Accordingly, the design process is easily adopted in the industry, i.e. does not require large investments or special skills of employees, so that robot assisted assembly or placement processes can be implemented by industry to a larger extend.

The robot-gripper may be a two finger gripper where one or both fingers are provided with a cut-out having the support surface. However, the gripper could also have other configurations like a vacuum or magnetic gripper provided with a cut-out with a designed support surface. Accordingly, the gripper may be one, two or more fingers or support members. Thus, it is understood that the gripper generally includes end-effectors to be used with a robot to grasp objects.

The fixture generally refers to a non-movable tool with a cut-out used for supporting objects, e.g. during assembly. An object may be positioned in the fixture by dropping or other positioning methods.

After the shape Gm(x,y) has been determined, the capability of the shape to correctly aligning the object may be determined. This capability may be assessed by determining final orientations and/or positions of the supported object for different initial orientations and/or positions of the object before being picked up by the gripper or oriented relative to the fixture. The final orientation and/or position of the object is determined by use of the determined shape Gm(x,y) of the support surface. The performance of the shape Gm(x,y) to align the object may be determined as a possible deviation between the determined final orientation and/or position and a desired final orientation and/or position. This performance may be used for determining if the determined final shape Gm(x,y) is suited for a given task, or if another shape Gm(x,y) should be determined.

It is noted that the combination of position and/or orientation may also be referred to as the pose of the object.

The method may be implemented on a computer for determination of the shape Gm(x,y) for the support surface based on the initial shape G(x,y) of the support surface. The initial shape may obtained from a physical object where the shape may be obtained by scanning of the object or an imprint of the object, or equivalently, the initial shape may be obtained from a CAD model of the object. Robotic manufacturing may include robotic assembly processes, positioning processes and other processes.

According to an embodiment the parameter q is indicative of a distance from the selected location (xs,ys) to one of the locations (xi,yj), i.e. to locations where the shaping function is applied. Accordingly, the shaping function provides possible modification values to the initial shape G(x,y) over the reference surface.

According to an embodiment, the method comprises determining different shapes Gm(x,y) of the support surface based on variations of an optimization input. Advantageously, different final shapes Gm(x,y) may be determined based on variations of certain variations of input parameters or different shaping functions F(q) in order to find a shape Gm(x,y) which offers sufficient performance.

For example, the variations of the optimization input comprises variations of the shaping function F(q). Such variations can include different types of functions, e.g. selected from a predefined selection of different functions or variations of a parameter of a parametrised function.

With respect to the shaping function F(q), the same shaping function F(q) may be used for determining a given shape Gm(x,y), i.e. the particular shaping function F(q) is not changed during the process where the shaping function is applied to different locations of the initial shape G(x,y). Advantageously, the predetermined variation of the shaping function may facilitate specific shape-properties of the final shape Gm(x,y) of the support surface.

Alternatively, the shaping function F(q) may be dependent on the locations (x,y) or the parameter q, so that shaping function is varied during the application to different locations of the initial shape G(x,y). For example, the slope of the shaping function may be a function of the distance from the location where the function is applied

Alternatively or additionally, the variations of the optimization input may comprises variations of geometric constraints of the shape Gm(x,y) or of the robot-gripper or fixture. Accordingly, constraints with respect to a maximum width of the opening of the support surface (i.e. cut-out), maximum depth of the cut-out, and other constraints such as dimensions of the finger of the gripper may advantageously be included as variation parameters in order to find the best geometric size of the gripper (e.g. finger thereof) or fixture.

According to an embodiment, the method further comprises determining an optimized shape Gm(x,y) based on an optimization condition.

For example, the optimization condition may be determined based on a final orientation and/or position of the supported object determined for different initial orientations and/or positions of the object before being picked up or oriented relative to the fixture, where the final orientation and/or position is determined by use of the determined shape Gm(x,y) of the support surface.

Advantageously, by quantifying the capability of the shape Gm(x,y) to align an object, e.g. in terms of a computed possible deviation between the determined final orientation/position and a desired final orientation/position based on different initial orientations/positions, a shape Gm(x,y) which is optimal with respect to the optimization condition can be determined automatically, e.g. by computing the alignment capability for a range of different optimization input.

Thus, the optimized shape Gm(x,y) may be determined by evaluating different candidate shapes of the determined different shapes Gm(x,y). The different shapes can be obtained by use of plurality of different optimization input, e.g. predetermined optimization input. The evaluation may include determination of the alignment property of a given shape Gm(x,y).

Alternatively, variations of the optimization input are determined based on the optimization condition. For example, known numerical optimization methods may be used for determining variations of the optimization input in order to determine a local or global optimum of the optimization condition.

According to an embodiment, the method is arranged for determining a shape Gm(x,y) of a support surface of a robot-gripper or fixture for supporting two or more different objects, where the initial shape G(x,y) of the support surface is based on an outer shape of a combination of the two or more different objects.

In this case the optimization condition is determined based on final orientations and/or positions of the two or more supported objects determined for different initial orientations and/or positions of the two or more objects before being picked up or oriented relative to the fixture (131), where the final orientations are determined by use of the shape Gm(x,y) of the support surface.

Advantageously, the method can be used for determining a shape Gm(x,y) for which more than one object can be supported. In this way a single gripper or fixture can be designed to handle different objects in a suitable way with respect to alignment capabilities. Accordingly, different grippers or fixtures for different objects used during an assembly process or positioning process may be replaced by a single gripper or fixture.

A second aspect of the invention relates to a robot-gripper or fixture for supporting an object picked up by a robot during robotic manufacturing, where the robot-gripper or fixture has a cut-out with a support surface for providing the support to the object, where the support surface has a shape Gm(x,y) obtainable by the method according to any claims 1-13.

A third aspect of the invention relates to a computer program product directly loadable into a memory accessible by a computing system, the computer program product comprises instructions for performing the steps of the method according to any of claims 1-13 when the computer program product is run on the computer system.

The computer program product may be provided on a computer readable storage medium or being downloadable from a communication network. The computer program product comprise instructions to cause the data processing system, e.g. in the form of a controller, to carry out the instruction when loaded onto the data processing system.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1A-B show robotic systems with grippers and fixtures,

FIGS. 2A-B illustrates a method for determining a modified shape of a support surface of a robot-gripper or fixture,

FIG. 3A shows a finger of a gripper with a cut-out of a specified width,

FIG. 3B illustrates how the initial shape of merged objects can be determined for the purpose of determining a support surface optimised for different objects,

FIGS. 4A-B shows an example of a two-finger gripper with plain fingers, and

FIG. 4C shows an example of a two-finger gripper provided with a cut-out.

### DETAILED DESCRIPTION OF EMBODIMENTS

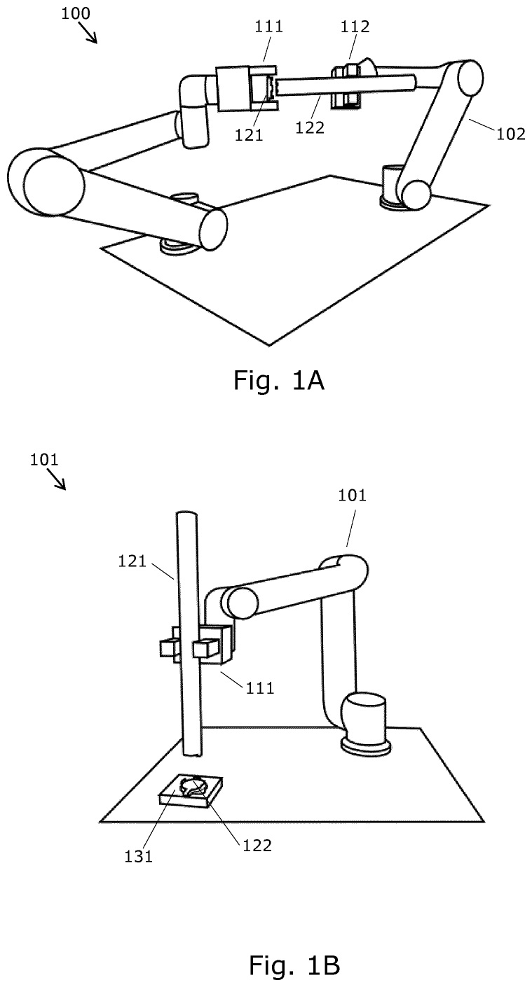

FIG. 1A shows a robotic system 100 which comprises two robots 101, 102 configured with respective robot-grippers 111, 112 which are arranged to hold respective objects 121, 122 during assembly of the objects 121, 122. For convenience, robot grippers 111, 112 are also referred to just as grippers 111, 112.

FIG. 1B shows a robotic system 101 which comprises one robot 101 configured with a gripper 111 and arranged to hold the first object 121. The robotic system further comprises a fixture 131 arranged to hold the second object 122. During assembly of the first and second objects 121, 122, the second object 122 is placed in the fixture 131, e.g. by use of the robot 101. The first object 121 is hold by the gripper 111 and moved into a suitable engagement with the second object 122 which is held by the fixture 131.

During the assembly process, the objects must be held with an orientation and position that enables correct assembly. Particularly, when the robot 101, 102 has to pick the object 121, 122 from a source of arbitrary oriented objects, it may happen that the object 121, 122 are held inappropriately with an orientation or position which deviates from the desired orientation and/or position. Due to this, the assembly may be impossible or lead to an unsatisfactory assembly quality.

In general, embodiments can be used for robotic manufacturing such as assembly, material processing and other robotic processes where a gripper 111, 112 or fixture 131 is used for supporting an object 111 picked up by a robot 101 during the robotic manufacturing.

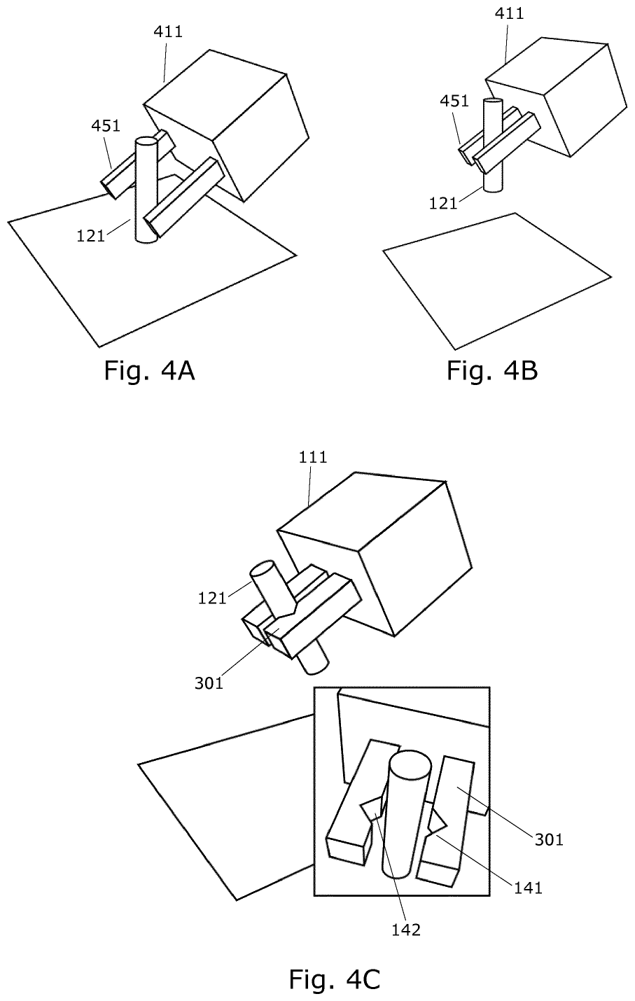

FIGS. 4A-B shows an example of two-finger gripper 411. In FIG. 4A, the gripper 411 with plain fingers 451 (i.e. without a cut out) approaches the object 121 which has an initial pose. FIG. 4B illustrates clamping of the object by the fingers 451 of the gripper. Since the gripper has plain fingers, the object is grasped and held with the initial pose, i.e. the orientation of the object 121 is not changed.

FIG. 4C shows an example of the two-finger gripper 111 where the fingers 301 are provided with a cut out 141 (see close-up view in FIG. 4C). FIG. 4C shows how the object 121 is re-oriented from the orientation in FIG. 4A into a desired orientation due to the cut out 141 of the fingers 301 (or one of the fingers). The re-orientation is effected by the shape of the cut-out 141. The cut-out 141 has a support surface 142 where at least a part, possibly different parts, of the support surface contacts the object 121 during the alignment and during the clamping when the object 121 is at rest.

The alignment or re-orientation capabilities of the gripper 111 with a cut out 141 is therefore higher than the gripper without a cut out 141. Good alignment capabilities decrease the risk of the object not being picked up or being poorly aligned, in an attempted grasp, directly improving the success-rate of the grasps and the assembly. This is of high value in industries where the failure of a grasp cannot only result in reduced throughput, but potentially result in destruction of products and equipment.

In general, the cut-out 141 and support surface 142 is designed so that the object 111 is correctly grasped by the gripper 111 for a range of different initial orientations and/or positions of the object 111.

The same principles applies to the design of a fixture 131 and its support surface (not shown) which may be shaped so that an object 111, 112 is reoriented and/or repositioned, if necessary, from an initial orientation/position into a desired orientation.

The support surface 142 of the gripper or fixture 131 comprises a surface which contacts the object 111 during the initial grasp and during the re-orientation to the final orientation/position.

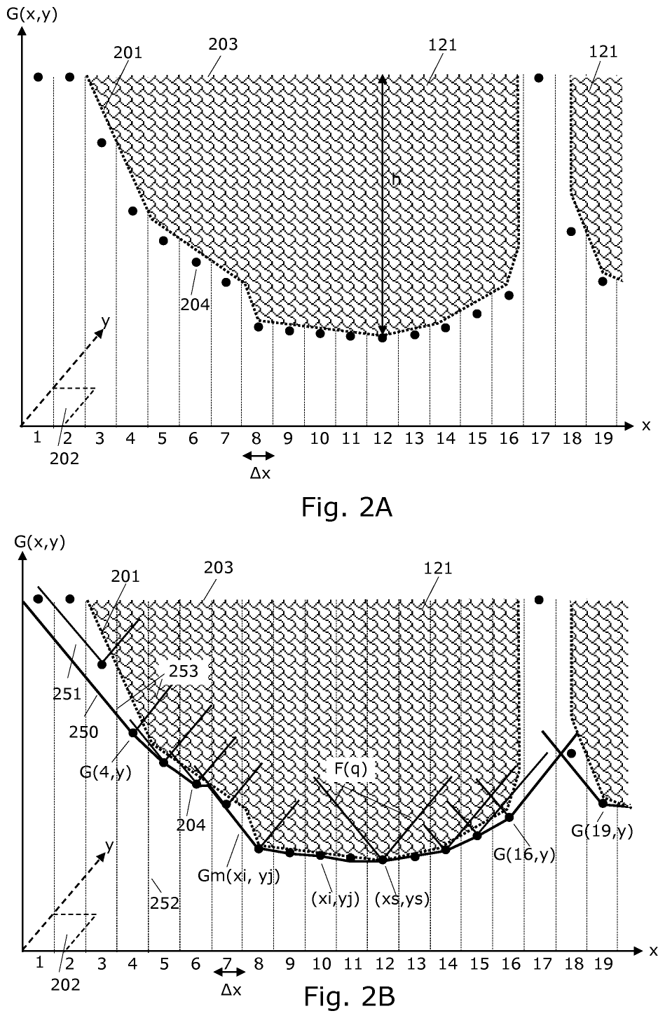

FIG. 2A illustrates a first step according to an embodiment for determining an initial shape G(x,y) of the support surface 142 for the gripper 111 or the fixture 131 based on an outer shape of an object 121. The initial shape G(x,y) as shown by dotted line 201 is determined based on the outer shape of the object 121. For example, the initial shape G(x,y) may be identical to a part of the outer shape of the object 121. Figuratively, the initial shape G(x,y) may be the shape obtained by pressing the object 121 into clay. In other examples, the initial shape G(x,y) need not be identical to the outer shape of the object 121. For example, a certain predetermined shape modification, e.g. smoothening, may be applied to the outer shape G(x,y) for the purpose of determining the initial shape G(x,y). As explained below, due to use of a discretised 2D grid, the initial shape G(x,y) may be obtained from a discretisation of the outer shape of the object 121.

The initial shape is a function of locations x,y on a reference surface 202. The reference surface 202 may the plane spanned by the x and y axes in FIG. 2A or any other plane or in general a surface.

The initial shape G(x,y) has an opening 203 corresponding to the opening of the cut-out 141. The deepest point of the initial shape, i.e. the largest vertical distance from the opening 203 to a surface point of the initial shape G(x,y), is denoted h. The vertical distance from the reference surface 202 to the initial shape G(x,y) could represent a material thickness from a surface of the gripper 111 or fixture 131 to the initial shape G(x,y).

The locations x,y may be discretised into a discretised grid, e.g. a 2D grid as illustrated with x-locations discretised into x-locations 1-19. The resolution of the discretisation is given the discretisation intervals Δx and Δy. For convenience the discretisation in only shown for the x-axis, and the initial shape G(x,y) which is a 3D surface which is represented by a cross-section of the 3D-shape.

The initial shape G(x,y) may be discretised into a discretised initial shape. This discretisation may be performed by mapping the lowest point (i.e. the deepest point with respect to the opening 203) within a given 2D discretisation interval Δx, Δy to the discretised initial shape at the discretisation point x, y. The discretised initial shape corresponds to the initial shape G(x,y) and is therefore also denoted by G(x,y). FIG. 2A shows the discretised values of the discretised initial shape as dots 204.

In order to determine a support surface 142 of a robot-gripper or fixture, a shape Gm(x,y) of a support surface 142 is determined based on the initial shape G(x,y). The shape Gm(x,y) or modified shape Gm(x,y) is determined as a modification of the initial shape by use of a shaping function F(q).

FIG. 2B shows an example of the shaping function F(q) applied to x=12 (y-coordinate is not shown). F(q) is a function of at least a parameter q, where q is determined relative to a selected location (xs,ys) where F(q) is applied. The shaping function F(q) is successively applied to different selected locations (xs,ys) selected among the locations (x,y).

The shaping function F(q) may be any function where q is defined dependent on a distance from the selected location (xs, ys) to neighbour locations (xi, yj), i.e. neighbour locations (xi,yj) to selected locations (xs,ys). The distance may be a scaled distance or other value indicative of a distance between the locations.

For example, the distance may be scaled distance, i.e. a weighted distance, determined as q=√(tx_i\hat{ }2+ty_k\hat{ }2), where tx_i and ty_k are obtained by dividing predetermined profile widths tx and ty into a set of steps tx_i and ty_k. The size of the steps tx_i and ty_k may be given by the discretisation of the initial shape G(x,y) so that it is equal to a multiple of the discretisation intervals Δx and Δy, respectively.

The shaping function F(q) may be an exponential function, e.g. a function F(q)=q\hat{ }b, where b can be any positive real number. Accordingly, the shaping function F(q) may be a linear function for b=1. The shaping function F(q) may be monotonically increasing or substantial monotonically increasing as a function of the parameter q. For example, the substantial monotonically increasing function F(q) may be non-increasing, e.g. constant or even slightly decreasing, in small local ranges, e.g. unimportant ranges.

The shaping function F(q) may be scaled by the height h being the maximum height of the initial shape G(x,y) of the support surface 142. Accordingly, the scaled or non-scaled version of the shaping function F(q) may be applied,

FIG. 2B shows how the linear shaping function F(q) is applied to a plurality of the selected locations (xs,ys) in a 2D representation of the 3D method.

For a plurality of neighbour locations (xi,yj) to the selected locations (xs,ys), modified shape points Gm(xi, yj) are determined based on the applied shaping function F(q) and the initial shape G(xi, yj) at the neighbour locations (xi,yj). This determination comprises a step of determining if a modified shape point Gm(xi, yj) provides an extension of the initial shape G(xi,yj) at the neighbour location (xi, yj). If an extension is provided, the initial shape G(xi,yj) is modified in the sense that the modified shape point Gm(xi, yj) is used as a shape point in the shape Gm(x,y) of the support surface. The resulting shape Gm(x,y) is illustrated by the 2D surface 250 which is a representation of the resulting 3D surface 250. The surface 250 corresponds to the support surface 142.

The extension is understood as an increase of the depth of the initial shape G(xi,yj) at the neighbour location (xi, yj), i.e. presence of an increase of the vertical distance (perpendicular to the xy plane) from the opening 203 to the modified shape point Gm(xi, yj) as compared with the initial shape point G(xi, yj). Alternatively, the extension can be understood as a decrease of the vertical height between modified shape point Gm(xi, yj) and the reference surface 202 as compared with the vertical height relative to the initial shape G(xi, yj).

In FIG. 2B, the area 251 located between the surface 201 of the initial shape G(x,y) and the resulting surface 250 of the resulting shape Gm(x,y) represent the material that is carved out or the extension of the initial shape G(x,y). The final cut-out 141 corresponds to the union of the areas 121 and 251, or corresponding volumes in 3D.

The dots 204 indicate the lowest value of the object 121 within discretisation intervals Δx, Δy in the discretised grid. For example, G(4,y) is modified to the value of G(x,y) at the intersection of the vertical discretisation line 252 and surface 201.

The shaping function F(q) is applied to every dot 204 or discretised value of G(x,y), as illustrated with profile lines 253 going out of the dot. These profile lines are shown for G(4,y), G(16,y) and other points.

The initial shape G(x,y) or initial cut-out 141 is then modified so that the new values of the modified shape Gm(x,y) corresponds to the lowest value within each discretisation interval Δx, Δy. In this way, modified shape points Gm(xi, yj) are determined for locations (xi,yj) based on the shaping function F(q), e.g. the profile lines 253, so that Gm(xi, yj) is set to the lowest value of the shaping function F(q) within each discretisation interval of locations (xi,yj).

If the shaping function F(q) provides an extension of the initial shape G(xi,yj) at the neighbour location (xi, yj), or equivalently, if a shape point Gm(xi, yj) modified by shaping function F(q) provides an extension of the initial shape G(xi,yj) at the neighbour location (xi, yj), the shape point Gm(xi, yj) modified by shaping function F(q) is used as a shape point in the shape Gm(x,y) of the support surface.

As shown in FIG. 2B, if a profile line 253, as the one left of G(4,y), has a lower value than G, then the value of G is updated with the value of the profile line 253. This is the case for x=1, 2 and 3, where the profile line of G(4, y) has a lower value than the dots in the grid. In cases where two profile lines meet, the lowest value of the two, or more, profile lines is taken. This is illustrated by G(16,y) and G(19,y), where G(x,y) is updated for x={16; 17} by the former profile and x={18,19} by the latter.

The updating of G with the value of the profile line may be performed so that the curve 250 is piecewise linear or so that the curve 250 is a stepped curve. The stepwise linear curve 250 may be obtained by connecting discretisation values of Gm(xi, yj) for neighbour coordinates xi or yj, or by extrapolating the curve 250 according to the profile line 253 over one or more coordinates xi, yj. The stepped curve, may be obtained by assigning values of Gm(xi, yj) to the curve 250 which are determined for a given coordinate xi or yj.

The resulting 3D surface 250 may be obtained by connecting the 2D curves in x and y directions by suitable surfaces. This is done taking the 2D position on the grid x, y, as the equivalent x and y coordinates in the 3D space and the value of G(x, y) as the remaining z component. Thereafter each point is connected to its surrounding neighbours to form small triangle meshes which form the final support surface Gm(x,y).

As noted above the step of obtaining a discretised version of the initial shape G(x,y) is optional. Accordingly, the shaping function F(q) may be applied for determining modified shape points Gm(xi, yj) by comparing the shaping function with the discretised or non-discretised initial shape function G(x,y) for locations (xi, yj) thereof.

In an embodiment, the obtained shape Gm(x, y) comprises a plurality of modified shape points Gm(xi, yj) and at least one unmodified shape point of the initial shape G(x,y). For example, the value for x=12, corresponding to the deepest point in the x and y directions may not be modified.

Examples for determining the updated profile Gm(x,y) include:
The updated profile for Gm(6,y) is updated based on the profile line to the right of the dot and is updated according to the discretisation principle to the left of the dot. This corresponds to the principles explained above.
The updated profile for Gm(7,y) is updated based on the profile line for the dot of Gm(8,y) since the profile line is lower than the dot for Gm(7,y).
The updated profile for Gm(4,y) is updated by connecting dots 204 for Gm(4,y) and Gm(5,y).

In order to determine an optimum shape Gm(x,y) of a support surface of a robot-gripper 121 or fixture 131 different candidate shapes Gm(x,y) may be determined based on variations of an optimization input.

The optimum shape may be a shape which satisfies a predetermined optimization condition.

The optimum shape Gm(x,y) may be determined based on an optimization function, i.e. a function which determines the variations by use of methods such as gradient methods or other suitable optimization method. In this case, the variations of an optimization input are determined based on the optimization condition so that the optimal input are those which satisfies the optimization condition.

Alternatively, the optimum shape Gm(x,y) may be determined by iterative variations of the optimization input, e.g. according to a predetermined sequence of variations. The optimum shape Gm(x,y) may be the shape which meets the optimization condition in the best way. Accordingly, the optimized shape Gm(x,y) could be determined by evaluating candidate shapes Gm(x,y) of the determined different shapes Gm(x,y) relative to the optimization condition.

As an example, the shaping function F(q) may be used as an optimization input which is varied in order to find the shaping function which provides the best or most suitable shape Gm(x,y) given the optimization condition.

As mention above, the shaping function F(q) could be a parametrised function, e.g. the function q\hat{ }b parametrised in b, or other function parametrised in one or more parameters. Variations of the parametrised function F(q) could be obtained by varying the one or more parameters, iteratively or by use of the optimization function.

Alternatively, a set of predetermined different shaping functions may be applied iteratively in order to find the shaping function which provides the most optimum shape of the support surface 142.

According to an embodiment, the same shaping function F(q) is used for determining a shape Gm(x,y). That is, the same shaping function F(q) may be applied to all dots 204 of the discretised initial shape G(x,y) or other computation points of the numerical representation of the initial shape G(x,y).

According to another embodiment, different shaping functions F(q) or variations of the shaping function F(q) is applied to the initial shape G(x,y). For example, the parameter b in q\hat{ }b could be varied as a function of the location where the shaping function F(q) is applied, or as a function of the variable q. Thus, in general the shaping function F(q) may be dependent on the locations (x,y).

In addition to or alternatively to generating variations of the shaping function F(q), one or more other optimization input may be varied in order to determine an optimum shape Gm(x,y) of a support surface of a robot-gripper 121 or fixture 131.

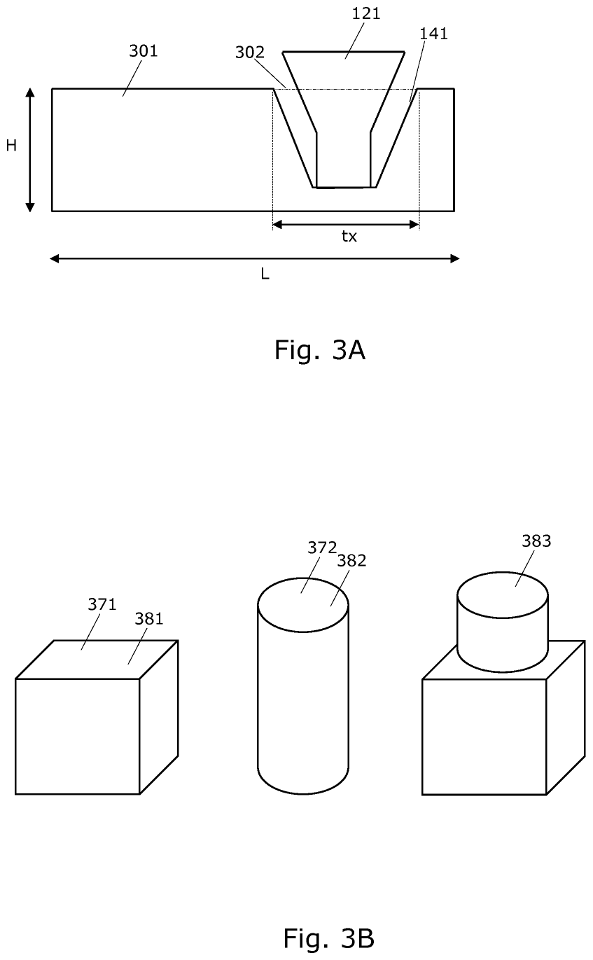

FIG. 3A illustrates a finger 301 of a gripper 111. The cut out 141 has a width tx which is set as a geometric constraint for the maximum width in the x direction of the cut out 141 at the opening 203. A similar geometric constraint for the width ty in the y direction may be specified in addition to or alternative to tx.

Geometric constraints for use as an optimization input may include one or more dimensions of the finger 301 such as the length L or height H which are varied during the process of determining the shape Gm(x,y) which may be optimized with respect to the optimization condition.

The optimization condition may be determined based on one or more scores.

The capability of a determined shape Gm(x,y) of the support surface 142 of a gripper 111 to alignment or re-orientate the object 121 from one specific initial pose to a final stable pose can be determined by use for known methods. Such methods may utilize friction, clamping force and geometric properties of the robot-gripper 111 or fixture 131.

Similarly, the capability of a determined shape Gm(x,y) of the support surface 142 of a fixture 131 to align an object 121 from a specific initial pose to a final stable pose can be determined. The determination may simulate the fall of the object 121 above the fixture 131.

One score of the optimization condition for a given shape Gm(x,y) of the support surface 142 may be determined based on determinations of deviations of final poses of a given object 121 from a desired pose. The final poses are determined for a plurality of different initial poses of the object. The different initial poses could be obtained from a random process, e.g. a random process which simulates a likely random distribution of different orientations and positions of objects 121 in a bin from which the objects are intended to be picked by a gripper 111. Similarly, the random process could simulate a random distribution of different orientations and positions of an object 111 relative to a fixture 131.

The optimization condition or one of the scores of the optimization condition may be determined as the angular and/or linear distance between the final pose of the object 121 and the desired pose.

Thus, in general the optimization condition may be determined based on a final orientation and/or position of the supported object 121 determined for different initial orientations and/or positions of the object before being picked up or oriented relative to the fixture 131, where the final orientation is determined by use of the determined shape Gm(x,y) of the support surface 142 of the gripper 111 or fixture 131.

The optimization condition may be determined each time a new shape Gm(x,y) has been determined and used for determining a variation of the optimization input, e.g. by use of known numerical optimization methods.

Embodiments of the method for determining the shape Gm(x,y) of a support surface 142 is generally applicable for supporting one or more different objects. The shape Gm(x,y) can be designed to support two or more different objects, by use of an initial shape G(x,y) of the support surface which is based on an outer shape of a combination of the two or more different objects.

FIG. 3B illustrates how the initial shape G(x,y) for supporting different objects 371, 372 is determined based on an outer shape 381 of the first object 371 and an outer shape 382 of the second object 372. The first and second shapes 381, 382 are combined into a combined shape 383 from which the initial shape G(x,y) is determined.

The outer shapes 381, 382 of the different objects 371, 372 can be combined in various ways.

For example, the combination or merging of different objects can be performed as an optimization method which determines the relative position and orientation of the objects 371, 372 which provides the best match of similar exterior structural features of the different feature. The optimised relative position and orientation provides a match where e.g. protruding structures of the two objects are aligned. For example, the match may be obtained by looking on the outer surface of an object from a specific point of view. The distance from the surface of the one object compared to that of the next object, using a predetermined view vector/direction provides a value for how similar they are if computed and added over the full region of the two objects.

In another example, the combination or merging of different objects is performed as an optimization method which determines the relative position and orientation of the objects 371, 372 which optimises overlap of the objects. As an advantage, this ensures that the cut-out generated will be as small as possible.

While these examples are based on an optimisation method, the combination of the objects 371, 372 may be performed in other ways including a manual merging of the outer shapes based on experience for a suitable merging.

When the shape Gm(x,y) of a support surface 142 is determined for supporting two or more different objects, the optimization condition used for determining the optimized shape Gm(x,y) is determined based on final orientations of the two or more supported objects for different initial orientations and/or positions of the two or more objects before being picked up or oriented relative to the fixture 131. In this case, the final orientations for the different objects are determined by use of the common shape Gm(x,y) for the different objects.

In summary the invention relates to a method for designing grippers and fixtures for handling objects in robotic manufacturing and pick-and-place tasks. To achieve this a method for determining a shape of the holding or support surface of the gripper or fixture is presented. This method includes steps of determining an initial shape of the support surface based on an outer shape of the object, applying a shaping function to different locations of the initial shape, determining modified shape points at locations of the initial shape by comparing the applied shaping function with the initial shape. If the application of the shaping function results in an extension of the initial shape G(xi,yj) at the neighbour location (xi, yj) this extension forms part of a modified support surface for the gripper or fixture. A method for determining an optimum shape of the support surface with respect to optimization conditions is also presented.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for determining a shape Gm(x,y) of a support surface of a robot-gripper (111) or fixture (131) used for supporting an object picked up by a robot during robotic manufacturing, the method comprises
determining an initial shape G(x,y) of the support surface for the robot-gripper or the fixture based on an outer shape of the object, where the initial shape is a function of locations (x,y) on a reference surface,
providing a shaping function F(q) being a function of at least a parameter q determined relative to a selected location (xs,ys) selected among the locations (x,y),
applying the shaping function F(q) to a plurality of the selected locations (xs,ys),
at a plurality of neighbour locations (xi,yj) to the selected locations (xs,ys), determine modified shape points Gm(xi, yj) based on the applied shaping function F(q) and the initial shape G(xi, yj),
if a modified shape point Gm(xi, yj) provides an extension of the initial shape G(xi,yj) at the neighbour location (xi, yj), use the modified shape point Gm(xi, yj) as a shape point in the shape Gm(x,y) of the support surface.

2. A method according to claim 1, where the parameter q is indicative of a distance from the selected location (xs, ys) to one of the locations (xi, yi).

3. A method according to claim 1, where the method comprises determining different shapes Gm(x,y) of the support surface based on variations of an optimization input.

4. A method according to claim 3, where the variations of the optimization input comprises variations of the shaping function F(q).

5. A method according to claim 1, where the same shaping function F(q) is used for determining a shape Gm(x,y).

6. A method according to claim 1, where the shaping function F(q) is dependent on the locations (x,y).

7. A method according to claim 3, where variations of the optimization input comprises variations of geometric constraints (tx, ty) of the shape Gm(x,y) or of the robot-gripper or fixture.

8. A method according to claim 1, where the method further comprises determining an optimized shape Gm(x,y) based on an optimization condition.

9. A method according to claim 8, where the optimization condition is determined based on a final orientation and/or position of the supported object determined for different initial orientations and/or positions of the object before being picked up or oriented relative to the fixture (131), where the final orientation and/or position is determined by use of the determined shape Gm(x,y) of the support surface.

10. A method according to claim 8, where determining the optimized shape Gm(x,y) comprises evaluating different candidate shapes of the determined different shapes Gm(x,y).

11. A method according to claim 8, where the variations of an optimization input are determined based on the optimization condition.

12. A method according to claim 1 for determining a shape Gm(x,y) of a support surface of a robot-gripper or fixture used for supporting two or more different objects, where the initial shape G(x,y) of the support surface is based on an outer shape of a combination of the two or more different objects.

13. A method according to claim 12, where the optimization condition is determined based on final orientations and/or positions of the two or more supported objects determined for different initial orientations and/or positions of the two or more objects before being picked up or oriented relative to the fixture (131), where the final orientations are determined by use of the shape Gm(x,y) of the support surface.

14. A robot-gripper (111) or fixture (131) for supporting an object (121, 122) picked up by a robot (101, 102) during robotic manufacturing, where the robot-gripper (111) or fixture (131) has a cut-out (141) with a support surface (142) for providing the support to the object, where the support surface has a shape Gm(x,y) obtained by the method according to claim 1.

15. A computer program product directly loadable into a memory accessible by a computing system, the computer program product comprises instructions for performing the steps of the method according to claim 1 when the computer program product is run on the computer system.
